(19) United States
(12) Patent Application Publication
(10) Pub. No.: US 2008/0112783 A1
(43) Pub. Date: May 15, 2008

(54) Stabilization mechanism with coupler for engaging with a cart and towing cylindrically shaped objects

(76) Inventor: Eddie Bruce Bock, Dallas, TX (US)

Correspondence Address: RUDOLPH J. BUCHEL JR., LAW OFFICE OF, P. O. BOX 702526, DALLAS, TX, 75370-2526, US

(21) Appl. No.: 11/985,449

(22) Filed: Nov. 15, 2007

Related U.S. Application Data
(60) Provisional application No. 60/859,125, filed on Nov. 15, 2006.

(51) Int. Cl. B65G 67/00

(52) U.S. Cl. 414/349

(57) ABSTRACT

The present invention relates to the movement of a stabilized safety device for cylindrically shaped objects to reduce the possibility of cylindrically shaped tanks toppling over and possibly shearing off the tank's valve assembly. The stabilization mechanism generally comprises a cylindrically shaped barrel, having a first open end and a second open end and which is fitted with a plurality of stabilization outriggers. Each of the plurality of outriggers extends from the exterior surface of the barrel, radially outward away from the barrel. The inner diameter of the barrel is sufficient to accept a pressurized cylinder or tank. The stabilization mechanism further comprises one or more fixtures for cooperating with and receiving a counterpart fixture on a cart. The fixtures are securely fastened to various components of the stabilization mechanism at locations thereon which are accessible to the cart. The cart generally comprises a handle and wheel arrangement which may be suggestive of a warehouse (or appliance) hand truck or the like. The cart further comprises one or more fixtures which are disposed thereon at corresponding locations to the arrangement of the respective corresponding fixtures on the stabilization mechanism. In the event that a gas cylinder is to be moved from one location to another, an operator merely engages the cylinder cart to the stabilization mechanism via the coupling fixtures and tows the cylinder on the cart.

The present application claims the benefit of copending U.S. Provisional Application No. 60/859,125, filed Nov. 15, 2006 and entitled “STABILIZATION MECHANISM WITH COUPLER FOR ENGAGING WITH A CART AND TOWING CYLINDRICALLY SHAPED OBJECTS”, hereby incorporated by reference in its entirety.

### BACKGROUND OF THE INVENTION

The present invention relates to a safety device for stabilizing and towing cylindrically shaped objects.

It is common practice in the industrial arts to pressurize various gaseous elements and compounds and then contain them in a cylindrically shaped pressure vessel or tank, normally called a cylinder. Typical contents of a cylinder include elements such as Argon (Ag), oxygen (O2), nitrogen (N2), chlorine (Cl2), fluorine (F), hydrogen (H2), helium (He), etc. and compounds such as acetylene (hydrocarbons having one or more carbon-carbon triple bonds), liquid petroleum gas (LPG, i.e., C3 or C4 such as propanes, butanes, etc.), carbon dioxide (CO2), compressed air, etc. There are two types of hazards associated with the use, storage and handling of these compressed gas cylinders: the chemical hazard associated with the cylinder's contents and the physical hazards represented by the presence of a high-pressure vessel proximate to people or property. The chemical hazard potential associated with the contents of these cylinders include corrosive, toxic, flammable, etc., while the physical hazard relates to the extremely high pressures at which the contents are contained. Compressed gas cylinders have extremely high potential energies due to the energy of their highly compressed contents.

Typically, these cylinders have a combination valve and port stem at the upper extent of the cylinder that penetrates the cylinder's wall to its inner cavity. Filling and unfilling the cylinder is accomplished through the valve and port stem. If the contents of a tank are released under controlled conditions, the corrosive, toxic, flammable and high energy attributes of the tank and its contents are of little consequence to a user. However, should an uncontrolled release occur, which may result from the tank toppling over and sheering its valve and port stem off, persons in the proximity of the release are in immediate danger. In fact, the potential energy contained in the fully 1.75 cu. ft. (ft3) pressurized cylinder of nitrogen gas, 1.74×106 ft. lb. (2.359×106 J), is comparable to the latent energy equivalent to about 0.5 lb. (0.25 kg) of TNT, the potential energy of TNT being 3.42×106 ft-lb. (4.63×106 J).

For any applications, these cylinders are transported to a location and installed at a station, typically by restraining compressed gas cylinders upright and securing them with a chain, strap, or cable to a stationary building support (i.e., a structural beam) or to a stabilization mechanism or cylinder cart to prevent cylinders from tipping or falling. Larger cylinders are moved from the transport vehicle to a storage area or usage station with a cylinder cart.

From the description above, it is apparent that any device for lessening the occurrence of uncontrolled releases from compressed gas cylinders and which further facilitates safely moving pressurized cylinders would be beneficial.

### BRIEF SUMMARY OF THE INVENTION

The present invention relates to a safety device for stabilizing cylindrically shaped objects to reduce the possibility of cylindrically shaped tanks toppling over and possibly shearing off the tank's valve assembly, while simultaneously providing the operator with a means for safely transporting the cylinder using the safety device. The mobility/safety device, therefore, reduces the occurrences of uncontrolled releases of the contents of a tank even during transport. With respect to an exemplary embodiment, a stabilization mechanism and cart are presented for stabilizing and transporting high pressure gas cylinders. The stabilization mechanism generally comprises a cylindrically shaped barrel, having a first open end and a second open end and which is fitted with a plurality of stabilization outriggers. Each of the plurality of outriggers extends from the exterior surface of the barrel, radially outward away from the barrel. The inner diameter of the barrel is sufficient to accept a pressurized cylinder or tank. The stabilization mechanism further comprises one or more fixtures for cooperating with and receiving a counterpart on a cart. The fixtures are securely fastened to various components of the stabilization mechanism at locations thereon which are accessible to the cart. The cart generally comprises a handle and wheel arrangement which may be suggestive of a warehouse (or appliance) hand truck or the like. The cart further comprises one or more fixtures which are disposed thereon at corresponding locations to the arrangement of the respective corresponding fixtures on the stabilization mechanism. In the event that a gas cylinder is to be moved from one location to another, an operator merely engages the cylinder cart to the stabilization mechanism and moves the cylinder. If desired, the operator merely disengages the cart from the stabilization mechanism. Thus, whenever a cylinder is at rest, the cart may be disengaged from a particular stabilization mechanism and used for transporting other cylinders. The aforementioned fixtures may take many forms, such as a pin and barrel coupler and/or a hub and fork type coupling mechanism. Furthermore, the couplers may be either horizontally or vertically oriented on the stabilization mechanism and cart.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1 is an illustration of a commercially available welding cart designed for storing and transporting compressed gas cylinders such as acetylene, argon, helium and oxygen;

FIG. 2 depicts a top view of an engagable slipover tank stabilizer configured in a horizontal ring configuration and adapted for engaging a wheeled cart in accordance with an exemplary embodiment of the present invention;

FIG. 3 depicts a forward-side view of an engagable slipover tank stabilizer configured in a horizontal ring configuration and adapted for engaging a wheeled cart in accordance with an exemplary embodiment of the present invention;

FIG. 4 depicts a rear view of an engagable wheeled cart adapted for engaging a slipover tank stabilizer in accordance with an exemplary embodiment of the present invention;

FIG. 5 depicts a side view of an engagable wheeled cart adapted for engaging a slipover tank stabilizer in accordance with an exemplary embodiment of the present invention;

FIG. 6 depicts a front view of an engagable wheeled cart adapted for engaging a slipover tank stabilizer in accordance with an exemplary embodiment of the present invention;

FIG. 7 depicts a rear view of a wheeled cart fully engaged with cart tank stabilizer, with an onboard compressed gas tank, in accordance with an exemplary embodiment of the present invention;

FIG. 8 depicts a side view of a wheeled cart fully engaged with cart tank stabilizer, with an onboard compressed gas tank, in accordance with an exemplary embodiment of the present invention;

FIG. 9 depicts a front view of a wheeled cart fully engaged with a tank stabilizer, with an onboard compressed gas tank, in accordance with an exemplary embodiment of the present invention;

FIG. 10 depicts a wheeled cart in the process of engaging a tank stabilizer in accordance with an exemplary embodiment of the present invention;

FIG. 11 depicts a tank stabilizer with an onboard tank in tow on a wheeled cart in accordance with an exemplary embodiment of the present invention;

FIGS. 12A and 12B depict a tank stabilizer and cart with a horizontally oriented pin and barrel type coupling mechanism in accordance with still another exemplary embodiment of the present invention;

FIGS. 13A and 13B depict a tank stabilizer and cart with a hub and fork type coupling mechanism in accordance with still another exemplary embodiment of the present invention; and

FIG. 14A, FIG. 14B and FIG. 14C depict a tank stabilizer without fixture couplers and cart with a coupling mechanism in accordance with still another exemplary embodiment of the present invention;

Other features of the present invention will be apparent from the accompanying drawings and from the following detailed description.

### DETAILED DESCRIPTION OF THE INVENTION

Mechanisms for safely storing pressurized gas cylinders are well understood in the prior art and include devices for chaining, strapping, or cabling the canisters to a stationary building support. These types are permanently mounted devices, while safe, do not offer the operator any flexibility where the cylinders can be stored and/or used. Recently, other devices have been realized for stabilizing gas cylinders, which offer portability. Several types of portable stabilization mechanisms for gas cylinders are disclosed by the inventor of the present application in U.S. Pat. No. 6,702,244 entitled “Stabilization Mechanism for Cylinderically Shaped Objects,” and is incorporated herein by reference in its entirety. These stabilizers may be configured as a “slipover” type, and generally comprise a cylindrically shaped barrel, having a first open end and a second open end and which are fitted with a plurality of stabilization outriggers. Each of the plurality of outriggers extends from the exterior surface of the barrel, radially outward away from the barrel. The inner diameter of the barrel is sufficient to accept a pressurized cylinder or tank. Some include wheels for moving the tank from one location to the next without the need of a cylinder cart or dolly.

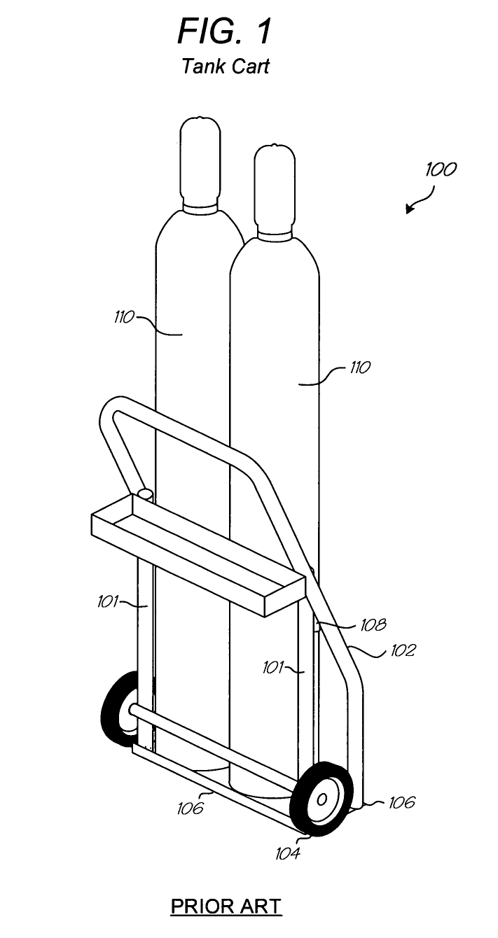

Another type of device known in the prior art for temporarily storing gas tanks in the upright position, which also offer added mobility, is a cylinder cart or welding cart. FIG. 1 is an illustration of a commercially available welding cart designed for storing and transporting compressed gas cylinders such as acetylene, argon, helium and oxygen. Typically, welding cart 100 is generally comprised of vertical support structure(s) 101 which is affixed to wrap-around handle 102 and to the rear end of nose plate 106. Either end of wrap-around handle 102 may also be connected to the forward end nose plate 106. Wheels 104 are secured to vertical support structure 101 via an axle, which is positioned proximate to the rear end of nose plate 106. Tanks 110 are loaded onto welding cart 100 at the forward end of nose plate 106 and secured to the cart with strap 108. Welding cart 100 offers moderate stability and mobility but is too expensive to use for tank applications where the cylinders are not continually being moved from one place to another. For those instances, it is more economical to store the tanks in a permanent vertical tank storage or cabinet and employ a welding cart only when the tank is in use.

What is needed in the art is a realistic understanding that present safety measures, with regard to compressed gas cylinders, are incongruous which results in a false sense of security, but which also offer a mechanism for safely transporting the cylinder.

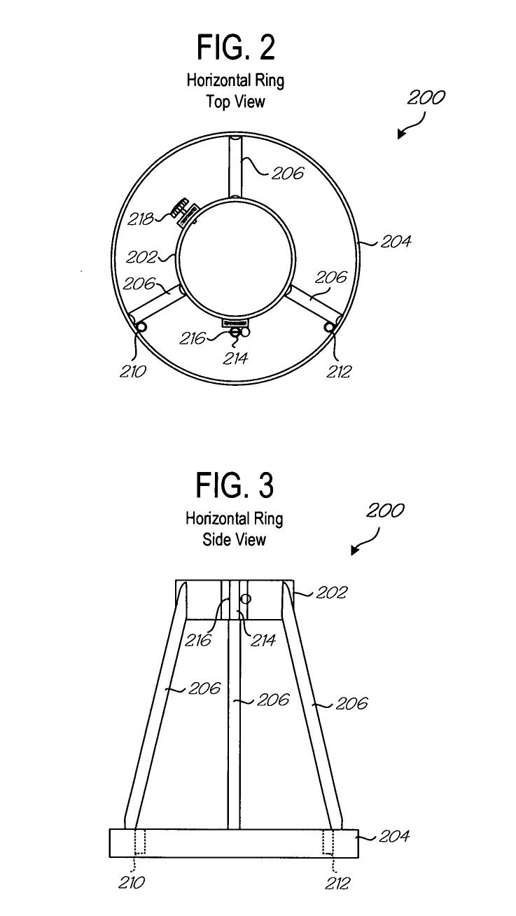

FIGS. 2 and 3 are pictorial representations of an engagable slipover tank stabilizer configured in a horizontal ring configuration and adapted for engaging a wheeled cart in accordance with an exemplary embodiment of the present invention. FIG. 2 depicts a top view of engagable slipover tank stabilizer 200 and FIG. 3 depicts a forward-side view of engagable slipover tank stabilizer 200. This particular slipover configuration is used herein merely for describing aspects of the present invention and is not intended to limit the scope of the present invention. Engagable slipover tank stabilizer 200 comprises stabilizer barrel 202 and horizontal ring 204, which is connected to stabilizer barrel 202 via a plurality of ring support members 206. When slipover tank stabilizer 200 is deployed on a cylindrical tank, horizontal ring 204 rests against the floor surface. Slipover tank stabilizer 200 will generally maintain its position on the cylindrical tank due to friction between the inner surface of stabilizer barrel 202 and the outer surface of the tank, however, an anti-slip mechanism may also be employed, such as set screw 218.

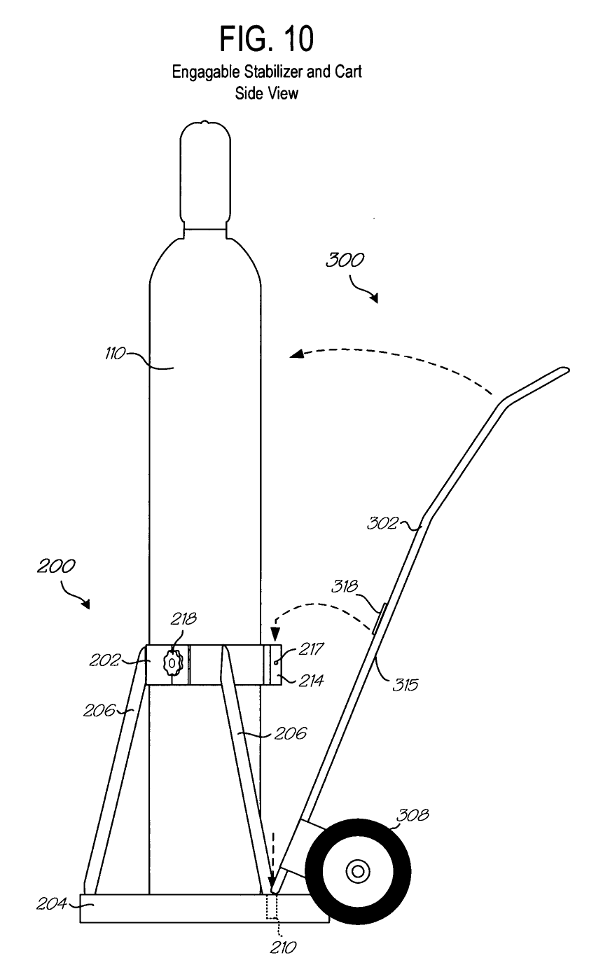

Engagable slipover tank stabilizer 200 differs from other slipover stabilizers in that it may be selectively engaged with a cart for moving an onboard tank from one location to another. This is accomplished by placement of one or more fixtures on the various components of engagable slipover tank stabilizer 200, but at locations thereon which are accessible to a cart. As depicted in the present figure, a pin and barrel coupling mechanism is employed for selectively engaging slipover tank stabilizer 200 to a cart. Here, three barrel couplers (210, 212 and 214) are disposed on the stabilizer. Barrel couplers 210 and 212 are located proximate to the lower extremity of slipover tank stabilizer 200 on one or both of horizontal ring 204 and support members 206. Barrel couplers 210 and 212 are approximately horizontally coplanar and positioned symmetrically with stabilizer barrel 202 for increased the stability under tow. A third coupler, barrel coupler 214, is affixed to stabilizer barrel 202 above the horizontal plane defined by barrel couplers 210 and 212 but is also symmetrical with stabilizer barrel 202. Barrel coupler 214 may be fitted with a hole (hole 217 depicted in FIG. 10) for receiving safety pin 216 while engaged with the cart.

It should be readily apparent that the present invention as embodied in cart 300, differs from prior art hand trucks in that the present cart lacks the nose plate typically employed for supporting the weight of the gas cylinders during towing. The mating couplers of the present invention eliminate the necessity of a nose plate on the cart, and more importantly, allow the operator to load a tank onboard cart 300 without tilting the tank. Essentially, the operator merely engages cart 300 with stabilizer 200, locks safety pin 216, and tows the tank with stabilizer 200 using cart 300.

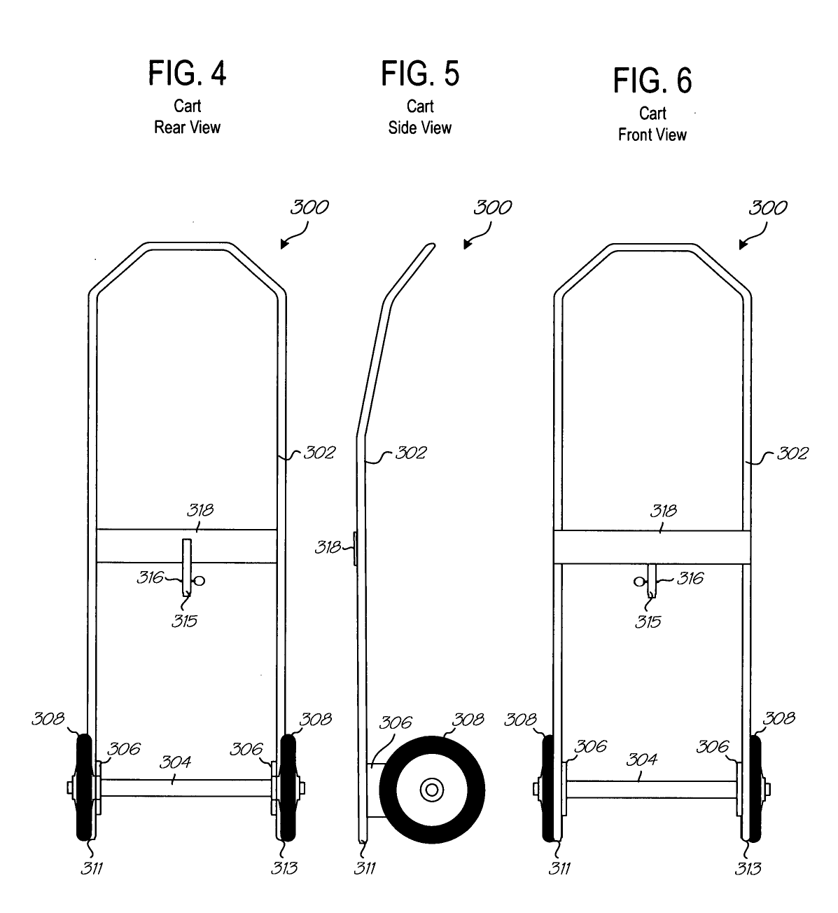

FIGS. 4, 5 and 6 are pictorial representations of an engagable wheeled cart adapted for engaging a slipover tank stabilizer in accordance with an exemplary embodiment of the present invention. FIG. 4 depicts a rear view of cart 300, FIG. 5 depicts a side view and FIG. 6 depicts a front view of engagable cart 300. In accordance with an exemplary embodiment of the present invention, cart 300 generally comprises handle 302 and a wheel chassis. The wheel chassis includes axle 304 for supporting each of wheels 308, and trucks 306 which are connected to either end of handle 302 for holding axle 304. Horizontal member 318 is securely affixed to the forward side of handle 302, at a position slightly higher than the top of stabilizer barrel 202. As mentioned above, engagable wheeled cart 300 provides a means for securely engaging with the fixtures on stabilizer 200 for towing stabilizer 200 and an adjoined tank.

Since exemplary stabilizer 200 is depicted with three barrel-type couplers, wheeled cart 300 should be fitted with three pin-type couplers at locations on the cart that correspond to the respective positions of the three barrel-type couplers. Hence, pin couplers 311 and 313 are formed on a horizontal plane corresponding to the respective locations of barrel couplers 210 and 212. In accordance with one exemplary embodiment, pin couplers 311 and 313 are formed by the lower extents of handle 302. It should be appreciated that the outer diameter of pin couplers 311 and 313 should correspond to the respective inner diameters of the barrel couplers 210 and 212, with, of course, some insertion clearance, therefore it may be necessary to increase or decrease the diameter of handle 302 to form barrel couplers 210 and 212. A third pin coupler, coupler pin 315, is connected to the rear-facing side of horizontal member 318 which correlates to the position of barrel coupler 214 on stabilizer barrel 202. Coupler pin 315 may be fitted with a hole for alignment with hole 217 on barrel coupler 214 and for receiving safety pin 216/316 once engaged in barrel coupler 214. As depicted in the figure, coupler pin 315 is approximately coplanar with the left and right portions of handle 302, and thus hidden by handle 302 in the side view. Coupler pin 315, or any of the couplers, may be fitted with a hole (not shown) for receiving safety pin 316. Safety pin 316 provides an extra measure of security, during towing, for engaging stabilizer 200 and cart 300.

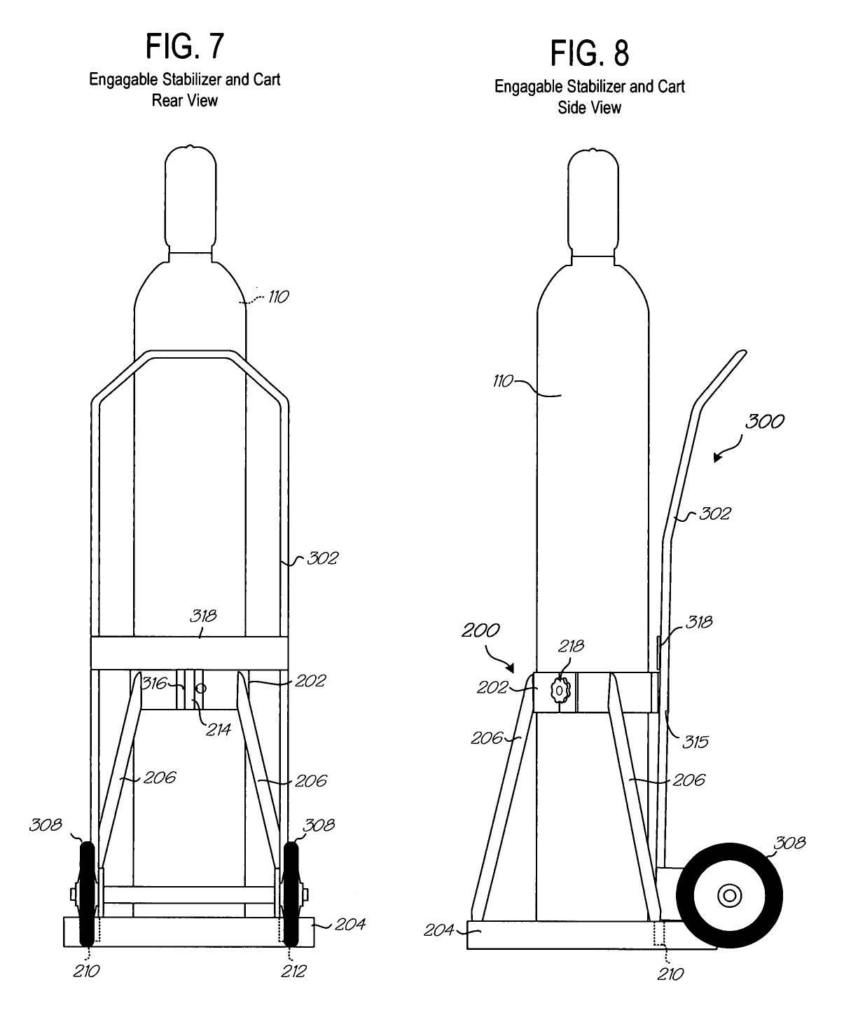

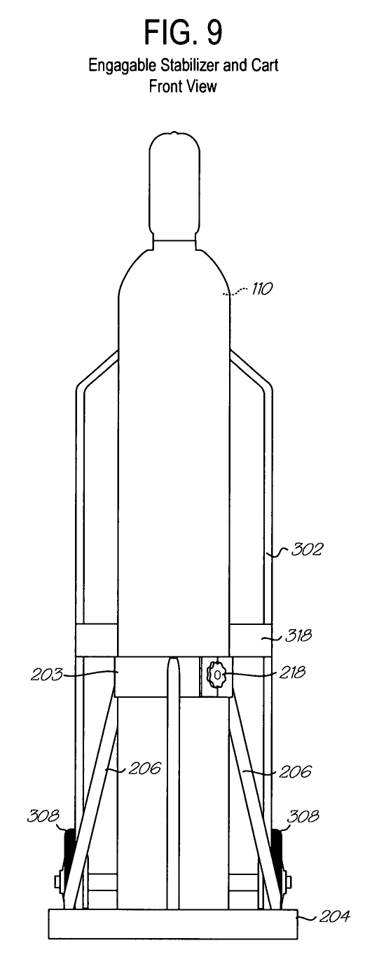

FIGS. 7, 8 and 9 depict stabilizer 200 fully engaged with cart 300 with a compressed gas tank onboard in accordance with an exemplary embodiment of the present invention. FIG. 7 depicts a rear view of cart 300 and stabilizer 200 loaded with tank 110. FIG. 8 depicts a side view and FIG. 9 depicts a front view of cart 300, stabilizer 200 and tank 110. FIG. 10 depicts cart 300 in the process of engaging with stabilizer 200 in accordance with an exemplary embodiment of the present invention. In accordance with this particular exemplary embodiment, each of barrel couplers 210, 212 and 214 are vertically oriented, top opening couplers on stabilizer 200. Therefore, in order to receive the corresponding pin couplers, each of pin couplers 311, 313 and 315 should have a corresponding vertical orientation and be downward-looking, i.e., each pin should have the lower portion open to be received in a corresponding barrel. As suggested by the illustration, cart 300 is engaged with stabilizer 200 by aligning the lowermost couplers with the body of cart 300, i.e., pin coupler 311 to barrel coupler 210 and pin coupler 313 to barrel coupler 212. Cart 300 is positioned at a slight incline from vertical and away from tank 110. Once pin coupler 311 is aligned with barrel coupler 210 and pin coupler 313 is aligned with barrel coupler 212, handle 302 is raised toward tank 110 and upper pin coupler 315 is then aligned with upper barrel coupler 214. When the alignment is true, cart 300 will drop as the coupler mates. It may be advantageous for the upper pin coupler to be slightly shorter than the lower pin coupler to allow the lower couplers to partially engage before mating the upper coupler. In so doing, the operator need not align all three couplers simultaneously, but merely the lower two and then by swinging the handle forward, the remaining upper coupler will then be aligned.

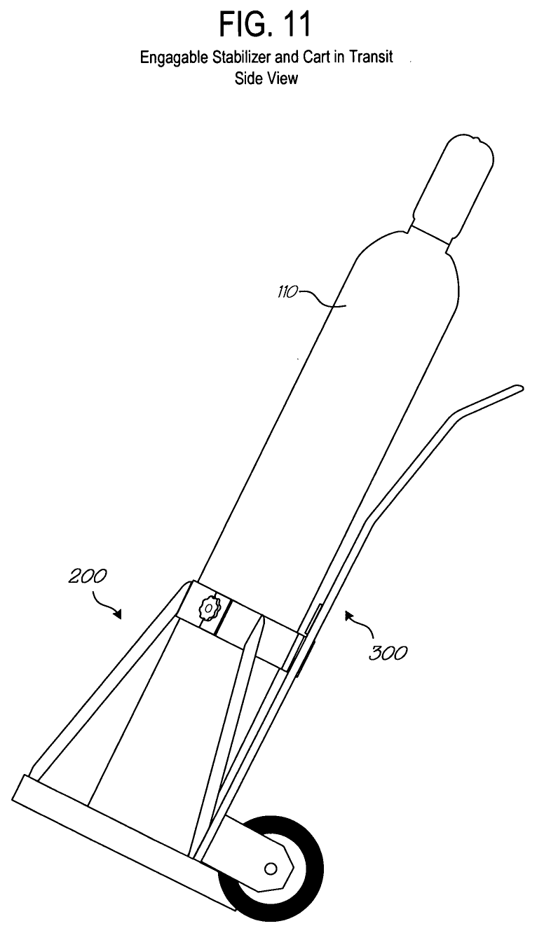

Safety pin 216/316 can then be inserted into hole 217. With stabilizer 200 fully engaged with cart 300, the onboard compressed gas tank can be towed in a manner similar to using a conventional hand truck, by tilting handle 302 rearward and rolling cart 300 by either pulling or pushing on the handle (see FIG. 11).

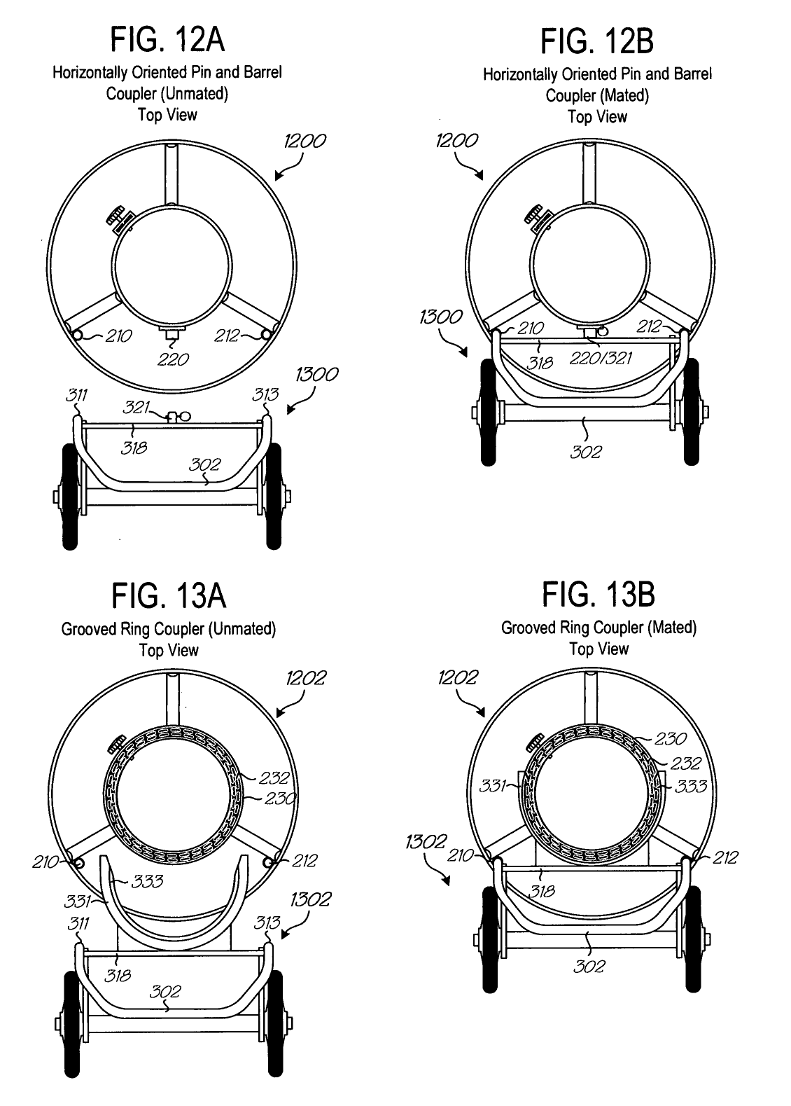

It should be appreciated that, although the present invention has been described with reference to vertically oriented pin and barrel type couplers, the orientation and type of the coupler can be altered without departing from the scope of the present invention. For instance, one or more of the barrel and pin couplers may be horizontally oriented as depicted in FIGS. 12A and 12B. FIGS. 12A and 12B depict a top view of stabilizer 1200 and cart 1300; FIG. 12A depicts stabilizer 1200 and cart 1300, apart and disengaged, while FIG. 12B shows stabilizer 1200 fully engaged with cart 1300. Here, notice that the vertically oriented upper coupler has been replaced with a horizontally oriented pin and barrel coupler. Pin 321 extends vertically from horizontal member 318 and corresponding barrel coupler 220 extends vertically from stabilizer barrel 202 toward the corresponding pin. Here, the operator aligns the lower two vertical couplers and swings the handle forward. As pins 311 and 313 are received in barrels 210 and 212, cart 1300 drops causing pin 321 to align with corresponding barrel coupler 220, which is received therein as the handle comes to vertical. Safety pin 216/316 can then be inserted into hole 217.

In accordance with still another exemplary embodiment of the present invention, a hub and fork type coupling mechanism can be employed for mating stabilizer 1202 engaged with cart 1302, as shown in FIGS. 13A and 13B. Here, stabilizer barrel 202 is fitted with ring 230. Ring 230 extends beyond the outer circumference of barrel 202 and is disposed on the lower surface of ring 230 as one or more concentric seating grooves 232. Disposed on horizontal member 318 of cart 1302 is fork 331. Fork 331 is configured with a concave U-shaped opening that corresponds in size and shape with ring 230. Also, on the upper surface of fork 331 concentric ring seating grooves 333 that correspond with concentric seating grooves 232.

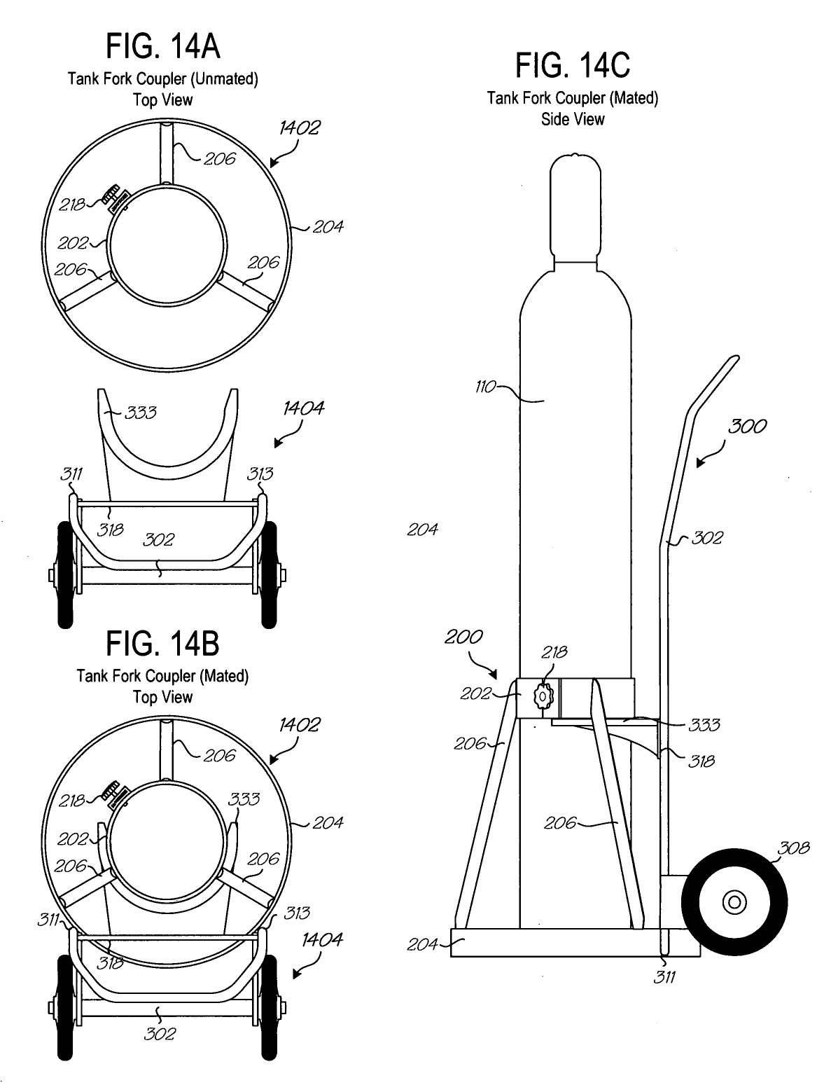

In accordance with still another exemplary embodiment of the present invention, couplers on cart 300 are configured to cooperate with an existing structure on the tank stabilizer. Thus, the tank stabilizers need not be modified for engaging with cart 300. For instance, the coupler on cart 300 may be configured to cooperate with the geometry of horizontal ring 204 or outrigger 206, or to the cross-sectional shape of the tank. For instance, FIGS. 14A and 14B depict a tank cart modified to engage with a conventional tank stabilizer, such as one taught in U.S. Pat. No. 6,702,244, with a tank cart modified to cooperate with the stabilizer. FIG. 14A depicts a top view of tank cart 1404 disengaged from tank stabilizer 1402, while FIG. 14B depicts a top view of tank cart 1404 engaged with tank stabilizer 1402 and FIG. 14C depicts a side view of tank cart 1404 engaged with tank stabilizer 1402. Notice that stabilizer 1402 is essentially identical to tank stabilizer 200, with the exception that stabilizer 1402 does not have any special fixture couplings for engaging with corresponding coupling on the cart. This is so because, in this instance, cart 1404 is configured with tank fork 333 which engages tank 110 and the lower rim of tank barrel 202. Thus, the upper coupler on stabilizer 1402 can be dispensed with. Furthermore, while couplers 311 and 313 remain, their purpose is to bias the outer edge of horizontal ring 204. In so doing, tank 110 and tank stabilizer 1402 are effectively locked in place and able to be towed from one location to the next as discussed directly above.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A device for transporting a stabilized cylindrically shaped object comprising:
a stabilizer for stabilizing cylindrically shaped objects, comprising at least one coupling mechanism affixed to said stabilizer;
a cart comprising:
a frame;
at least one wheel; and
at least one corresponding coupling mechanism for cooperating with coupling mechanism, said at least one corresponding coupling mechanism affixed to said cart.

2. The device recited in claim 1, wherein the stabilizer further comprises:
a barrel having a first opening and a second opening, whereby said first opening and said second opening of said barrel being of sufficient diameter for accepting said cylindrically shaped object; and
a plurality of outriggers, each of the plurality having a barrel end connected to said barrel and having a distil end that extends in an approximate radial direction from said barrel.

3. The device recited in claim 1, wherein the cart further comprises a handle, wherein the handle forms at least a portion of the frame.

4. The device recited in claim 1, wherein the at least one coupling mechanism and the one corresponding coupling mechanism further comprise a pin and a barrel for receiving the pin.

5. The device recited in claim 2, wherein the cart further comprises a handle, wherein the handle forms at least a portion of the frame.

6. The device recited in claim 5, wherein the cart further comprises:
a horizontal ring connected to the plurality of outriggers and proximate to the distil end each of the plurality of outriggers.

7. The device recited in claim 6, wherein the stabilizer further comprises at least one lower coupling mechanism and at least one upper coupling mechanism, said lower coupling mechanism affixed to one of the horizontal ring and one of the plurality of outriggers.

8. The device recited in claim 7, wherein the cart further comprises at least one lower corresponding coupling mechanism and at least one upper corresponding coupling mechanism, said lower coupling corresponding mechanism affixed to frame.

9. The device recited in claim 1, wherein the at least one coupling mechanism and the one corresponding coupling mechanism are oriented in a vertical direction.

10. The device recited in claim 1, wherein the at least one coupling mechanism and the one corresponding coupling mechanism are oriented in a horizontal direction.

11. The device recited in claim 1, wherein the at least one coupling mechanism and the one corresponding coupling mechanism further comprise a fork and a ring for receiving the fork.

12. The device recited in claim 1, wherein the cart further comprises:
at least two wheels;
an axle;
a truck for supporting one of the axle and the at least two wheels.

13. The device recited in claim 1, wherein the at least one coupling mechanism and the one corresponding coupling mechanism further comprise an alignment hole for receiving a safety pin.

14. The device recited in claim 2, wherein the at least one coupling mechanism is one of the barrel and the plurality of outriggers.

15. The device recited in claim 13, wherein the at least one corresponding coupling mechanism engages a structure of the stabilizer.

16. The device recited in claim 13, wherein the at least one corresponding coupling mechanism engages one of the barrel and the plurality of outriggers.
